(19) United States
(12) Patent Application Publication
(10) Pub. No.: US 2008/0299018 A1
(43) Pub. Date: Dec. 4, 2008

(54) BIOMASS TO LIQUIDS PROCESS

(76) Inventors: Ken Agee, Bixby, OK (US); Gary Roth, Spring, TX (US)

Correspondence Address: Hall, Estill, Hardwick, Gable, Golden &;Nelson, P.C., 100 North Broadway, Chase Tower, Suite 2900, Oklahoma City, OK, 73102, US

(21) Appl. No.: 12/124,657

(22) Filed: May 21, 2008

Related U.S. Application Data
(60) Provisional application No. 60/939,294, filed on May 21, 2007.

(51) Int. Cl. B01J 19/00

(52) U.S. Cl. 422/187

(57) ABSTRACT

The present invention relates to a biorefinery system for conserving resources, whereby the system has a refining unit, at least one bio-oil unit, and a host site.

### CROSS-REFERENCE TO RELATED APPLICATIONS

The present application claims the benefit under 35 U.S.C. 119(e) of U.S. Provisional Application Ser. No. 60/939,294, filed May 21, 2007, which is hereby expressly incorporated by reference herein in its entirety.

### FIELD OF INVENTION

The present invention relates to a system that includes a refining unit, a bio-oil unit, and a host facility, whereby the host facility shares resources, including but not limited to utilities, infrastructure, or raw materials, with the refining unit and the bio-oil unit. More particularly, not by way of limitations, the present invention relates to a system and process that combines a manufacturing or production facility with a biomass to liquid facility.

Systems for converting biomass into bio-oils and/or fuels are well known. Further, there are a whole host of systems that convert naturally occurring bio-oils into fuel. As such, it is well known to use any of a variety of systems to convert biomass into energy. All of the processes for conversion require raw material inputs and energy. The energy that is utilized in such processes can be in a variety of forms. Also, the processes for conversion produce excess raw material or energy. As such, the excess inputs and outputs are taken from or shipped to facilities remote from the bio-fuel production facility. This means energy utilized during transfer may be needlessly wasted. What is desired is a system for sharing resources between facilities to save costs and time. Shared resources could include both inputs and outputs.

There are a variety of manufacturing processes that are both energy intensive and produce by-products and use biomass which could be useful in the production of biofuels. These processes produce resources, which as referred to herein, are energy and raw materials, essentially inputs and outputs. One issue associated with utilizing these resources to produce biofuels is that typically they have to be transported long distances, which destroys some efficiencies associated with using such materials. In terms of production of biofuels there is typically excess heat produced which could be readily used by facilities which require heat. Again, the issue is transporting such energy in a way that it can be efficiently utilized. As such, it is desired to share resources between a host plant or manufacturing facility and a bio-oil refinery in a cost effective manner.

Biomass refers to living and recently living biological material which can be used as fuel or for industrial production. Common biomass includes plant matter grown for use and also includes plant or animal matter used for production of fibers, chemicals, or heat. Biomass may also include biodegradable waste that can be burned as fuel. Biomass can also include things such as paper pulp or by-products of paper production. All of the mentioned materials are classified as resources. Biofuels include bio ethanol, biomethanol, biodiesel, and biogas.

As one example, the manufacturing of paper produces biomass by-products. During the manufacturing of paper caustic sodium hydroxide and sodium sulfide are used to extract lignon from wood chips in large pressure vessels called digesters. From this, pulping liquor is extracted which is then concentrated and burned in a recovery boiler to recover inorganic chemicals and to produce steam for the milling process. As such, the paper manufacturing process produces potential resources such as steam or paper pulp, which is cellulosic material pulp and paper processing also involves gathering and transporting large volumes of raw biomass, i.e. trees, that may have extraneous materials available for use.

As such, it is desired to have a bio-energy facility proximal to a host facility that produces resources. In particular, it is desired for the two facilities to share resources for increased efficiency. It is to such a system that the present invention is directed.

### SUMMARY OF THE INVENTION

The present invention relates to a biorefinery system designed for conserving resources. The system includes a refining unit, for converting bio-oil into fuel and other derivatives, and at least one bio-oil unit which houses unrefined bio-oils. The bio-oils can include natural bio-oils, liquefaction products, and combinations thereof. A host site is included which can receive from or provide resources to the refinery unit, bio-oil unit, or both. The host site is included in the biorefinery system of the present invention. The natural bio-oils are selected from the group including animal fats, plant oils, vegetable oils, algae oils, and combinations thereof. The liquefaction products are sourced from the group consisting of direct liquefaction, indirect liquefaction, and combinations thereof. Related to this, the direct liquefaction process can include processes such as pyrolysis, hydrgenolysis, thermolysis, or thermal depolymerization. Indirect liquefaction processes include gasification, Fischer-Tropsch synthesis, methanol synthesis, or higher alcohol synthesis.

The host site of the biorefinery system can be a wastewater treatment plant, slaughterhouse, food production facility, grain processing facility, ethanol plant, pulp plant, or pulp and paper plant. To produce products, the refining unit can utilize processes such as hydro processing technologies selected from the group consisting of hydrocracking, hydrotreating, and hydroisomerization. Also, the liquefaction products can be sourced from the group consisting of forest residues, crop residues, MSW, sludge from water treating plants, waste chemicals from biomass sources such as glycerol from biodiesel production ect.

As such, the bio-oil unit is located adjacent the refinery, with both located proximal to the host site.

### BRIEF DESCRIPTION OF THE DRAWINGS

FIG. 1 is a schematic showing a host system sharing resources with a bio-oil unit.

FIG. 2 is a schematic showing a host system sharing resources with a refining; unit.

FIG. 3 is a schematic showing a host system sharing resources with a bio-oil unit and a refining unit.

### DETAILED DESCRIPTION OF THE PREFERRED EMBODIMENT

The present invention relates to a biorefinery system for sharing resources between a host facility and bio-energy facility which includes a bio-oil unit, a refinery, or both. Resources are materials or inputs that are utilized in the production of a product or good, with resources utilized in the production of biofuel. Resources include raw materials, such as biomass, water, and energy. Energy includes electricity, heat, steam, products that can be converted to energy (including gas and oil), or other similar products. If raw materials are transferred from the host site such materials will typically be waste or by-products. Thus, the present invention relates to an integrated biorefinery or bio-energy facility located adjacent to a host site to share utilities and/or infrastructure and provide resources, including waste heat and/or energy. Such an arrangement will typically include a refining unit that upgrades bio-oils to produce finished fuels, chemicals or chemical intermediate products.

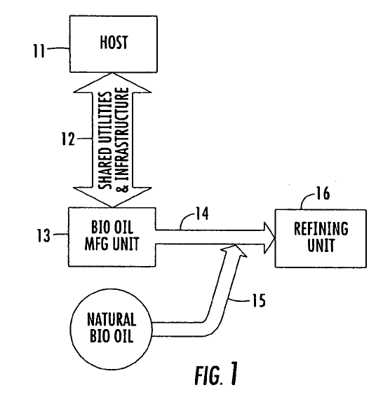

Referring to FIG. 1, in one embodiment, a bio-oil facility 13 (also referred to as a bio-oil unit or bio-oil manufacturing unit) is located at or proximal a host site 11 (also referred to as a host facility or host unit) where utilities and other infrastructure: services are provided, and energy and byproducts are utilized (via a two-way conduit 12). The bio-oil facility 13 provides a bio-oil product 14 that is transported to a refining unit 16 (also referred to as a refining facility) where, optionally, another naturally occurring feedstock 15 is also processed.

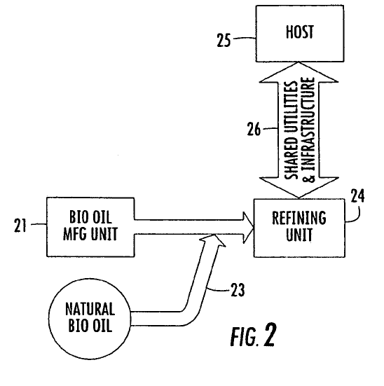

Referring to FIG. 2, another embodiment of a bio-energy system is shown, bio-oil manufacturing unit 21 provides a bio-oil product for further processing in a refining unit 24. The refining unit 24 may supplement this bio-oil with other naturally occurring feedstock 23. The refining unit 24 is located at a host site 25 where utilities and other services are supplied and the waste heat and byproducts of refining are utilized (via a two-way conduit 26).

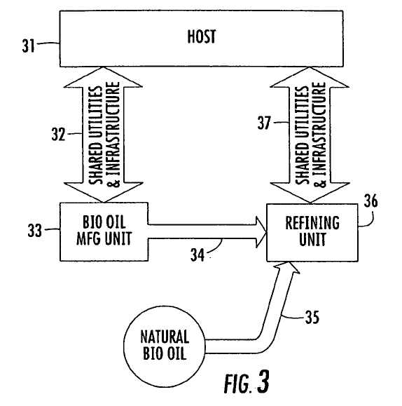

FIG. 3 is another embodiment of the present invention where a host site 31 provides utility services to, and takes byproducts and waste heat from both a bio-oil manufacturing unit 33 and a refining unit 36, through two-way conduits 32 and 37. A bio-oil product 34 is refined in the refining unit 36, where other naturally occurring feedstock 35 may also by processed.

As used herein the term biorefinery or bio-energy facility at minimum includes a refining unit 16, 24, and 36 and a bio-oil unit 13, 21 and 33. The bio-oil unit 13, 21 and 33 will house bio-oils that can be naturally occurring fats and oils from plant (including vegetable and algae) or animal sources. The bio-oils may also be manufactured from low cost biomass sources such as forest residues, crop residues or on purpose bio-energy crops.

Any facility that provides infrastructure and requires waste heat could be a host facility located near the bio-energy facility. The manufacturing of bio-oils may be derived from “direct liquefaction” processes such as, pyrolysis, hydrgenolysis, thermal depolymerization, or similar techniques. The manufacturing of bio-oils may also include “indirect liquefaction” processes such as, gasification followed by Fischer-Tropsch synthesis, or methanol or higher alcohol synthesis.

Processes that utilize direct or indirect liquefaction methods can be complex and difficult to operate resulting in reduced runtime. The biorefinery of the present invention can take advantage of the naturally occurring fats and oils as a fraction of the feed to the refining unit 16, 24 and 36 at times to modify yields and/or products qualities. The biorefinery of the present invention can also utilize the naturally occurring fats and oils as the majority feed at times of reduced operation or shut down of bio-oil manufacturing capacity. As such, the system contemplates refining feed stock streams from two sources.

All or a portion of the biorefinery of the present invention may be located adjacent to a host site 11, 25 and 31 to share resources, utilities, infrastructure, waste heat or energy. The refining unit 16, 24 and 36 may be adjacent to the host site 11, 25 and 31 and a bio-oil manufacturing unit 13, 21 and 33 may also be adjacent to the host site 11, 25 and 31. Optionally either unit may be located at a remote site. The biorefinery may have multiple bio-oil manufacturing sites feeding one refining unit and therefore may have multiple host sites. For example five bio-oil manufacturing units could be located adjacent to five host sites and the bio-oil product could all be shipped to a single refining unit at one of the five locations or a different location.

The host site 11, 25 and 31 can be defined as a facility that utilizes any of a variety of resources during manufacturing. Additionally, the host site 11, 25 and 31 will produce waste produce waste products that may be useful to the refining unit 16, 24 and 36. The waste products can be converted and initially passed to the bio-oil unit 13, 21 and 33. As such, the host facility 11, 25 and 31 can also be defined as a plant or manufacturing facility that requires or produces excess resources. Resources include energy, water, heat, raw material, waste material, biomass, ect. Examples of host facilities 11, 25 and 31 include ethanol plants, pulp plants, and pulp and paper plants, waste water plants, ect. Additionally, the host facility 11, and 31 can be defined as one that is located proximal to the refining facility 16, 24 and 36 in such a way as to efficiently share resources.

The host facility 11, 25 and 31 and bio-energy facility can be connected via a variety of means which are dictated by the resources to be shared. Piping can link the facilities to promote exchange of materials. The piping can allow for products in liquid or a particular liquid to be exchanged. Lines for transferring power can also link the host facilities 11, 25 and 31 and the bio-energy facilities. Other aspects that could be shared include physical plants and software. Obviously, anything that saves money and can be connected or shared between the facilities can be used. Generally, distance between the plants is immaterial so long as resources are efficiently shared. For some situations it is preferred for the plants to be proximal. This is likely true of exchanging resources such as heat/steam or materials such as paper pulp.

In summary, the host facility 11, 25 and 31 is located proximal to a bio-energy facility, so as to promote sharing of resources. Any arrangement will satisfy the contemplated system so long as resources can be shared between the facilities. It is also preferred if a cost savings results. By proximal what is contemplated is a system whereby resources can be shared in such a way as to not increase costs, and preferably save costs.

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A biorefinery system designed for conserving resources, comprising:
(a) at lease one refining unit for converting bio-oil into fuel and other derivatives;
(b) at least one bio-oil unit which houses unrefined bio-oils selected from the group consisting of natural bio-oils, liquefaction products, and combinations thereof; and,
(c) at least one host site which can utilize or provide resources to the at least one refining unit, the at least one bio-oil unit, or both.

2. The biorefinery system of claim 1 wherein the natural bio-oils are selected from the group consisting of animal fats, plant oils, vegetable oils, algae oils, and combinations thereof.

3. The biorefinery system of claim 1 wherein the liquefaction products are sources from the group consisting of direct liquefaction, indirect liquefaction, and combinations thereof.

4. The biorefinery system of claim 3 wherein the indirect liquefaction process is selected from the group consisting of, pyrolysis, hydrgenolysis, thermolysis, and thermal depolymerization.

5. The biorefinery system of claim 3 wherein the indirect liquefaction process is selected from the group consisting of gasification, Fischer-Tropsch synthesis, methanol synthesis, and higher alcohol synthesis.

6. The biorefinery system of claim 1 wherein the at least one host site is selected from the group consisting of waste water treatment, slaughter house, food production facility, grain processing facility, ethanol plants, pulp plants, and pulp and paper plants.

7. The biorefinery system of claim 1 wherein the at least one refining unit uses hydroprocessing technologies selected from the group consisting of hydrocracking, hydrotreating, and hydroisomerization.

8. The biorefinery system of claim 1 wherein the liquefaction products are sourced from the group consisting of forest residues, crop residues, MSW, sludge from water treating plants, waste chemicals from biomass sources such as glycerol from biodiesel production ect.

9. The biorefinery system of claim 1 wherein the at least one bio-oil unit is located adjacent the at least one refining unit.
